(19) United States
(12) Patent Application Publication
(10) Pub. No.: US 2016/0246648 A1
(43) Pub. Date: Aug. 25, 2016

(54) INFORMATION TECHNOLOGY RESOURCE PLANNING

(71) Applicants: Harish Bantwal KAMATH, Bangalore (IN); Arvind BADIGER, Bangalore (IN); Sunil SAMUEL, Bangalore (IN); Ramaprasad Kudli VENKATARAMANAIAH, Bangalore (IN); HEWLETT-PACKARD DEVELOPMENT COMPANY, L.P., Houston, TX (US)

(72) Inventors: Harish Bantwal Kamath, Bengalooru (IN); Aravind Badiger, Bangalore (IN); Sunil Samuel, Bangalore (IN); Ramaprasad Kudli Venkataramaniah, Bangalore (IN)

(21) Appl. No.: 15/028,035

(22) PCT Filed: Oct. 9, 2013
(86) PCT No.: PCT/IN2013/000611

§ 371 Date: Apr. 8, 2016

(51) Int. Cl. G06F 9/50; G06F 9/54; G06F 3/0484; G06F 9/48

(52) U.S. Cl. CPC G06F 9/5011; G06F 9/4881; G06F 9/546; G06F 3/04842

(57) ABSTRACT

Methods and systems for planning IT resources for delivering high availability of applications in an IT environment are described. In one implementation, a plurality of predefined resource requirements associated with delivery of high availability of applications in the IT environment is presented to a user. Each predefined resource requirement comprises a set of resource redundancy levels for delivery of high availability. A user selection of a predefined resource requirement selected from the plurality of predefined resource requirements is received. The set of resource redundancy levels corresponding to the selected predefined resource requirement are displayed. A user selection of a resource redundancy level selected from the displayed set is received. IT resources present in the IT environment that meet the selected resource redundancy level are identified. Allocation attributes of the identified IT resources are presented for allocation of IT resources.

### BACKGROUND

In modern day information technology (IT) environments, measures are taken to provide high availability of applications that utilize IT resources, including hardware resources, such as computers, servers, storage devices, and network components, and software resources, such as operating systems. High availability of an application in an IT environment refers to availability of the application for users to access, with minimum, nearing to zero, down-time. The high availability is delivered through redundancy in IT resources in the IT environment. The redundant IT resources act as back-up for running the application, when a dedicated IT resource(s) fails unexpectedly.

### BRIEF DESCRIPTION OF DRAWINGS

The detailed description is provided with reference to the accompanying figures. In the figures, the left-most digit(s) of a reference number identifies the figure in which the reference number first appears. The same numbers are used throughout the drawings to reference like features and components.

FIG. 1(a) illustrates an IT environment implementing a resource planning system, according to an example of the present subject matter.

FIG. 1(b) illustrates a resource planning system, according to an example of the present subject matter.

FIG. 2 illustrates the resource planning system, according to an example of the present subject matter.

FIG. 3(a) illustrates an example of user interface for planning IT resources for delivering high availability of an application in an IT environment, according to an example of the present subject matter.

FIG. 3(b) illustrates an example of user interface for planning IT resources for delivering high availability of an application in an IT environment, according to an example of the present subject matter.

FIG. 3(c) illustrates an example of user interface for planning IT resources for delivering high availability of an application in an IT environment, according to an example of the present subject matter.

FIG. 4 illustrates a method of planning IT resources for delivering high availability of an application in an IT environment, according to an example of the present subject matter.

FIG. 5 illustrates a network environment for planning IT resources for delivering high availability of an application in an IT environment, according to an example of the present subject matter.

### DETAILED DESCRIPTION

The present subject matter relates to methods and systems for planning IT resources for delivering high availability of applications in an IT environment. The IT environment is a system environment that includes a variety of hardware components, operating systems, and applications, which are implemented by an organization for people to work in the organization. For the purposes of the present subject matter, the applications may be understood as software applications that are accessed by users in the IT environment, and require IT resources, such as servers, network components and storage devices, for their functioning. Planning of IT resources for delivering high availability of applications may include allocation of redundant servers, network components, storage devices, etc., as backup resources.

Generally, a high availability cluster is configured for delivering high availability of an application in an IT environment. The high availability cluster includes a group of redundant IT resources that can be utilized to keep the application running, in case one or more dedicated IT resources fail. A distinct high availability cluster is configured for delivering high availability of each application. To configure the high availability cluster for an application, the resource planning is performed, in which resource requirements for delivering the high availability are identified, and a set of IT resources is allocated and grouped in the high availability duster based on the redundancy required to meet the identified resource requirements. The resource requirements refer to resource level redundancies that have to be provided in the IT environment for ensuring the high availability of the application. The resource requirements also depend on the extent of delivery of high availability of the application in the IT environment. The extent of delivery of high availability is defined in terms of number of 9s, for example, three 9s, four 9s, or five 9s, that is, 99.9%, 99.99%, or 99.999% of total hours per year. The high availability delivered with three Os refers to the application down-time of 0.1% of total hours in one year, that is, 24*365/1000 hours. Planning the right set of IT resources for configuring the high availability cluster helps in delivering the resources to access and run the application with a minimum down-time of application.

Planning of IT resources for high availability of applications in the IT environment is done manually. In manual planning, the resource requirements for delivering high availability are listed manually, and the inventory of IT resources for configuring the high availability cluster is compiled manually. The persons involved in listing of resource requirements and compiling the inventory details need to have a good understanding of the resource requirements for delivering high availability and have significant knowledge of inter-dependencies between the applications and the IT resources. For this, either the help of IT experts is taken during the planning stage, or the persons involved in planning have to acquire knowledge for planning the IT resources. The time consumed in acquiring the knowledge is substantially large. Also, the time consumed in manual compilation of the inventory details is substantially large. This makes the planning of IT resources for delivering high availability of applications in IT environment slow and, hence, less productive. Further, when similar IT resources are present in large numbers, the selection and allocation of IT resources for configuring the high availability cluster is difficult. Thus, the high availability cluster developed based on manual planning of IT resources may not be an optimized cluster.

Methods and systems for planning IT resources for delivering high availability of applications in an IT environment are described herein. The methods and the systems of the present subject matter provide improved use of the available IT resources for configuring high availability clusters for delivering high availability of applications. Also, substantially less manual effort is required by people during the planning stage, due to automation of the planning process in accordance with the present subject matter. Further, with the methods and the systems of the present subject matter, the planning of IT resources can be performed by a person having substantially less knowledge and understanding, which is otherwise required in the planning stage.

The system, in accordance with the present subject matter, may be a computing device communicatively coupled to an IT environment that provides a tool to a person for planning IT resources for delivering high availability of applications in the IT environment. The computing device may include, but is not limited to, a desktop computer, a laptop, a tablet, and the like. For the purpose of the description herein, the person performing the planning is hereinafter referred to as a user. The user may be the administrator, an IT consultant, or such involved in IT resource planning for delivering high availability.

For planning IT resources for delivering high availability of an application, a plurality of predefined resource requirements associated with different levels of delivery of high availability of applications are presented to the user by a computing device. A predefined resource requirement is indicative of resource redundancies at one or more levels that have to be provided in the IT environment for delivering of high availability of the applications. The resource redundancy may be in the applications, servers, network communication channels, data storage sites for data replication, etc., depending on the level. The provisioning of resource redundancy at a level means delivering the high availability at a distinct level. The resource redundancy at a level, hereinafter, may be referred to as “level of resource redundancy” or “resource redundancy level”.

The number of levels of resource redundancies in a predefined resource requirement is indicative of a degree of delivery of high availability of applications in the IT environment upon meeting that predefined resource requirement. The degree of delivery of high availability increases with an increment in the levels of resource redundancies in the predefined resource requirements. To illustrate this with examples, the predefined resource requirement indicative of the lowest degree of delivery of high availability may include a base level of resource redundancy which is capable of providing a minimum level of redundancy in the IT resources. The minimum level of redundancy may include redundancy of applications and server. The predefined resource requirement indicative of a relatively higher degree of delivery of high availability may include the base level of resource redundancy plus a network level of resource redundancy. The network level of resource redundancy may indicate to redundancy of network communication channels, with one channel for communication of heart-beats and the other channel for communication of application data. Similarly, the predefined resource requirement indicative of a further higher degree of delivery of high availability may include the base level of resource redundancy plus the network level of resource redundancy plus a multi-site level of resource redundancy. The multi-site level of resource redundancy may indicate to redundancy of storage sites at which the application data is stored. In this, the application data is replicated and stored at multiple storage sites.

The plurality of predefined resource requirements are presented to the user, by the computing device, for selection based on the application for which IT resources are to be planned for delivering high availability. In an example implementation, the plurality of predefined resource requirements include a variety of resource requirements, based on the “best practices” of bringing resource level redundancies for delivery of high availability of applications in the IT environment.

Upon presenting the plurality of predefined resource requirements to the user, one of the predefined resource requirements may be selected by the user depending on the application for which IT resources are to be planned for delivering high availability. The predefined resource requirement selected by the user refers to a set of resource redundancy levels. Upon selecting the predefined resource requirement, the user can plan IT resources for each of the corresponding resource redundancy levels, in order to deliver high availability of the application in the IT environment. As mentioned earlier, the predefined resource requirements presented to the user indicate different degrees of delivery of high availability of the application in the IT environment based on the corresponding set of resource redundancy levels. Thus, by selecting one of predefined resource requirements and planning the IT resources for it, the user can selectively define a degree of delivery of high availability of an application in the IT environment.

For planning the IT resources, the user can select one of the resource redundancy levels from the set, at an instance. The user selection of a id resource redundancy level is received by the computing device, and IT resources present in the IT environment which meet the resource redundancy level indicated in the user selection are identified. The IT resources are identified by the computing device based on a predefined resource identification rule associated with the resource redundancy level indicated in the user selection. In an example, for the network level of resource redundancy referring to the redundancy of network communication channel, the predefined rule may indicate to identify all the servers, physical, logical or virtual servers, present in the IT environment that have two or more network cards. With two or more network cards in the server, separate network cards can be allocated for the heart-beat communication and the application data communication. In another example, for the multi-site level of resource redundancy referring to the redundancy of storage sites at which the application data is stored, the predefined rule may indicate to identify all the sites present in the IT environment where the replicated application data can be stored.

In an example implementation, predefined resource identification rules are configured corresponding to all the resource redundancy levels in all the predefined resource requirements. Such a predefined rule is utilized by the computing device to identify the IT resources in order to meet the resource redundancy level indicated in the user selection.

Upon identifying the IT resources, attributes of the identified IT resources, based on which the IT resources can be allocated to configure a high availability cluster, are presented to the user by the computing device. The attributes are presented for allocation by the user to meet the resource redundancy level indicated in the user selection. The attributes of IT resources may include identification attributes, such as names and identifier codes, based on which the IT resources can be allocated by the user. The attributes of the IT resources may also include functional attributes, such as storage array parameters for multi-site storage devices, and timing parameters, for example, time-outs for network components and start-up timings for computing systems that may be set by the user to allocate the IT resources. The attributes of the IT resources, hereinafter, are referred to as allocation attributes. In an example, for the network level of resource redundancy referring to the redundancy of network communication channel, the servers having two or more network cards are identified by the computing device. For the identified servers, the allocation attributes indicating names of the servers, and details of the network cards per server are presented to the user by the computing device for allocation.

Subsequent to this, the allocation attributes of the IT resources identified by the computing device are selected or set by the user against the resource redundancy level indicated in the user selection. The allocation attributes selected or set by the user are received by the computing device, and the IT resources based on the selected or set allocation attributes are grouped into a high availability cluster by the computing device. The high availability cluster thus groups the IT resources that can be utilized to deliver high availability of the application in the IT environment.

The above described procedure can be repeated by the user to plan IT resources for each resource redundancy level in the predefined resource requirement selected by the user. The same high availability cluster is configured based on the allocation attributes of all the IT resources allocated by the user to meet the set of resource redundancy levels in the selected predefined resource requirement, and to deliver the overall high availability of the application in the IT environment.

Further, in an example implementation, allocation attributes of the IT resources that are pending for selection or setting against the resource redundancy level indicated in the user selection are identified by the computing device. Such allocation attributes are referred to as pending allocation attributes. The user is then prompted by the computing device to select or set the pending allocation attributes. This prevents from missing out on allocation of IT resources against the selected resource redundancy level.

Further, in an example implementation, resource redundancy levels, corresponding to the selected predefined resource requirement, against which planning of IT resources is pending are identified by the computing device, Such resource redundancy levels are referred to as pending resource redundancy levels of the selected predefined resource requirement. The user is then prompted by the computing device to select the pending resource redundancy levels, one at a time, and plan IT resources against the pending resource redundancy levels. This prevents from missing out on planning of IT resources against any resource redundancy levels in the selected predefined resource requirement.

Further, in an example implementation, strength of high availability that will be delivered in the IT environment with respect to the selected predefined resource requirement is provided by the computing device. The strength of high availability is based on number of resource redundancy levels, corresponding to the predefined resource requirement selected by the user, against which IT resources have been planned by the user through the computing device. In an example implementation, the strength of high availability may be provided as a percentage based on the number of resource redundancy levels for which IT resources have been planned and the total number of resource redundancy levels in the predefined resource requirement selected by the user. For example, if the selected predefined resource requirement includes six resource redundancy levels, and the planning has been done for three of the resource redundancy levels, the strength of high availability is 50%. The strength of high availability may provide an indication to the user about the capability of the IT environment to deliver high availability of the application with respect to the selected predefined resource requirement.

With the methods and the systems of the present subject matter, the predefined resource requirements are presented to the user by the computing device, and the IT resources present in the IT environment are identified′ to meet the resource redundancy levels in the selected predefined resource requirement for delivering high availability. With this, the user does not have to manually list down the resource requirements or compile the inventory details of the IT resources present in the IT environment. Thus, the planning of IT resources for delivering high availability consumes substantially less time. Further, planning can be performed even by substantially inexperienced users with substantially reduced manual efforts.

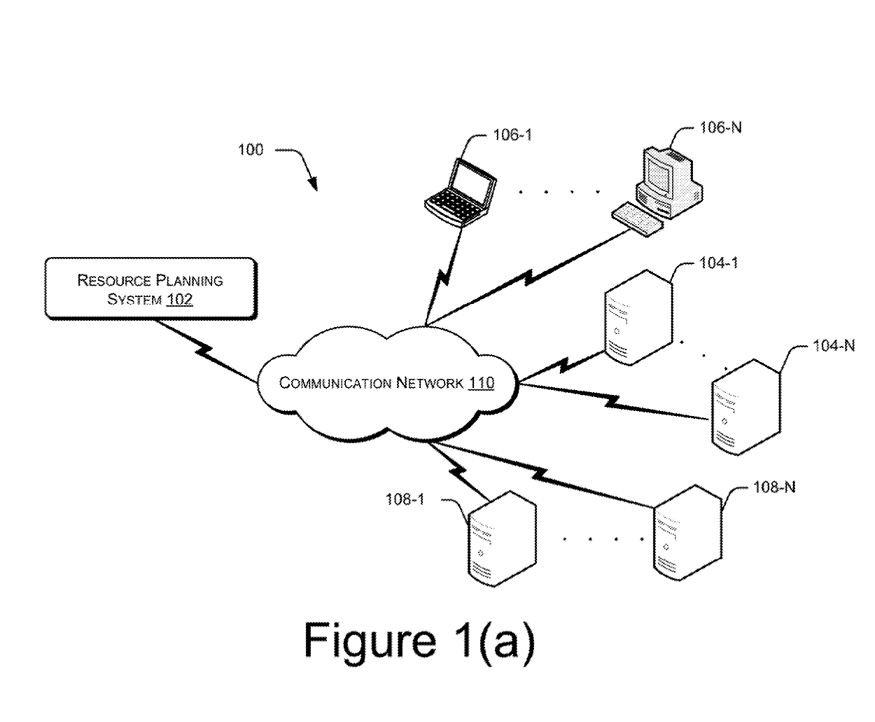

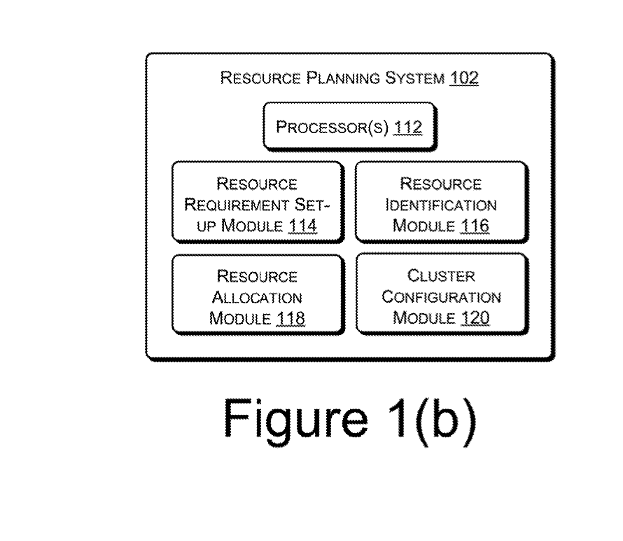

The above methods and systems are further described with reference to FIGS. 1 to 5. It should be noted that the description and figures merely illustrate the principles of the present subject matter. It is thus understood that various arrangements can be devised that, although not explicitly described or shown herein, embody the principles of the present subject matter. Moreover, all statements herein reciting principles, aspects, and embodiments of the present subject matter, as well as specific examples thereof, are intended to encompass equivalents thereof.

FIG. 1(a) schematically illustrates an IT environment 100 implementing a resource planning system 102, according to an example of the present subject matter. The IT environment 100 may be a public IT environment or a private IT environment. The resource planning system 102 may be a machine readable instructions-based implementation or a hardware-based implementation or a combination thereof. The resource planning system 102 described herein can be implemented in a computing device, such as a desktop computer, a laptop, a tablet, and the like. The resource planning system 102 in a computing device enables the planning of IT resources for delivering high availability of applications in the IT environment, in accordance with the present subject matter.

As shown in FIG. 1(a), the IT environment 100 includes a plurality of servers 104-1, . . . , 104-N that host one or more applications and store data associated with the applications, and includes a plurality of computing device 106-1, . . . , 106-N through which users of the applications can access the hosted application(s). The plurality of servers 104-1, . . . , 104-N, hereinafter may be collectively referred to as servers 104, and individually referred to as a server 104. The servers 104 may include physical, logical and virtual servers. The plurality of computing devices 106-1, . . . , 106-N, hereinafter may be collectively referred to as computing devices 106, and individually referred to as a computing device 106. The computing devices 106 may include desktop computers, laptops, tablets, and the like. Further, the IT environment 100 may include one or more data storage sites 108-1, . . . , 108-N, collectively and individually referenced to as data storage site(s) 108. The data storage site 108 may be a back-up server where the replicated application data can be stored. The servers 104, the computing devices 106, and the data storage sites 108 are the IT resources in the IT environment 100. The IT environment 100 may further include network devices (not shown), such as routers, switches, and the like, through which the various devices in the IT environment 100 communicate with each other.

Further, as shown in FIG. 1(a), the resource planning system 102, the servers 104, the computing devices 106, and the data storage sites 108 are communicatively coupled to each other through a communication network 110. In an example, the resource planning system 102 can communicate with the servers 104, the computing devices 106, and the data storage sites 108, for the purpose of planning of IT resource for delivering high availability of applications in the IT environment 100, in accordance with the present subject matter.

In an example implementation, the resource planning system 102, the servers 104, the computing devices 106, and the data storage sites 108 may be communicatively coupled over the communication network 110 through one or more communication links. The communication links are enabled through a desired form of communication, for example, via dial-up modem connections, cable links, and digital subscriber lines (DSL), wireless or satellite links, or any other suitable form of communication. The communication network 110 may be a wireless network, a wired network, or a combination thereof. The communication network 110 can also be an individual network or a collection of many such individual networks, interconnected with each other and functioning as a single large network, e.g., the Internet or an intranet. The communication network 110 can be implemented as one of the different types of networks, such as intranet, local area network (LAN), wide area network (WAN), and the internet. The communication network 110 may either be a dedicated network or a shared network, which represents an association of the different types of networks that use a variety of protocols, for example, Hypertext Transfer Protocol (HTTP), and Transmission Control Protocol/Internet Protocol (TCP/IP), to communicate with each other.

FIG. 1(b) illustrates the resource planning system 102, according to an example of the present subject matter. The resource planning system 102 includes processor(s) 112. The processor(s) 112 may be implemented as microprocessors, microcomputers, microcontrollers, digital signal processors, central processing units, state machines, logic circuitries, and/or any devices that manipulate signals based on operational instructions. Among other capabilities, the processor(s) 112 fetch and execute computer-readable instructions stored in the memory. The functions of the various elements shown in FIG. 1(b), including any functional blocks labeled as “processor(s)”, may be provided through the use of dedicated hardware as well as hardware capable of executing machine readable instructions.

As shown in FIG. 1(b), the resource planning system 102 includes a resource requirement set-up module 114, a resource identification module 116, a resource allocation module 118, and a cluster configuration module 120. The resource requirement set-up module 114, the resource identification module 116, the resource allocation module 118, and the cluster configuration module 120 are coupled to the processor(s) 112.

In an example implementation, for the purpose of planning IT resources for delivering high availability of applications in the IT environment 100, a user may access the resource planning system 102. The user may include the administrator or an IT consultant involved in planning IT resources for delivering high availability of applications.

In an example implementation, the resource requirement set-up module 114 presents a plurality of predefined resource requirements to the user. Each of the predefined resource requirements includes one or more resource redundancy levels that indicate requirements of resource redundancy at different levels for delivery of high availability of applications at those levels. For the purpose of description herein, the predefined resource requirements, hereinafter, are referred to as “resource requirements” and are referenced as “RR”, and the resource redundancy levels are referenced as “RRL”. Table 1 illustrates examples of resource redundancy levels RRL1, RRL2, . . . , RRL6. The resource requirements are specified based on a combination of resource redundancy levels. The specification against each resource redundancy level describes the requirements of resource redundancy. The resource redundancy levels illustrated in Table 1 are for the purpose of explanation and are by no means restricted to the examples of the mentioned herein. Other similar resource redundancy levels are also possible.

TABLE 1

| Resource | Resource | |
|---|---|---|
| Redundancy | Redundancy | |
| Level | Level Name | Specification |
| RRL1 | Base | Redundancy in application and server. |
| RRL2 | Single | Redundancy in network |
| | Heartbeat + | communication channels, with |
| | Single Data | heartbeat and application data |
| | | communication on separate single |
| | | channels. |
| RRL3 | Separate | Redundancy in network |
| | Heartbeat + | communication channels, with |
| | Single Data | heartbeat communication on two |
| | | channels and application data |
| | | communication on a separate single |
| | | channel. |
| RRL4 | Virtual Machines | Redundancy in hypervisors, with each |
| | on Separate | virtual machine running on a separate |
| | Hypervisor | hypervisor. |
| RRL5 | Asynchronous | Redundancy in data storage site, with |
| | Data Replication | asynchronous data replication. |
| RRL6 | Synchronous Data | Redundancy in data storage site, with |
| | Replication | synchronous data replication. |

As illustrated, RRL1 is for “Base” indicating base level resource redundancy. For this, redundancy in application and server is required for delivering high availability of the application. RRL2 is for “Single Heartbeat+Single Data”. For this, separate communication channels are required, one for heartbeat communication and one for application data communication. RRL3 is for “Separate Heartbeat 4. Single Data”. For this, separate communication channels are required, two for heartbeat communication and one for application data communication. RRL4 is for “Virtual Machines on Separate Hypervisor”. For this, redundancy in hypervisors is required, so that each virtual machine is run on a separate hypervisor. RRL6 is for “Asynchronous Data Replication”. For this, redundancy in data storage sites or data replication sites is required, with data being replicated and stored asynchronously. RRL6 is for “Synchronous Data Replication”. For this, redundancy in data storage sites or data replication sites is required, with data being replicated and stored synchronously.

Table 2 illustrates examples of resource requirements RR1, RR2, RR6, defined based on the resource redundancy levels RRL1, RRL2, RRL6, illustrated in Table 1. The combination or the set of resource redundancy levels defines the degree of delivery of high availability for each resource requirement. The degree of delivery of high availability associated with the resource requirements increases from RR1 to RR6. The increase in the degree of delivery of high availability is due to either the increase in the number of resource redundancy levels or the nature of resource redundancies required by the combination of resource redundancy levels. For example, the degree of delivery of high availability associated with RR4 is higher than that for RR1 to RR3 because of more number of resource redundancy levels. The degree of delivery of high availability is higher for RR3 than that for RR1 and RR2 because for the nature of resource redundancies required by RR3. The resource requirements illustrated in Table 2 are for the purpose of explanation and are by no means restricted to the examples of the mentioned herein, Other similar resource requirements are also possible.

TABLE 2

| Resource | Resource Requirement Levels |
|---|---|
| Requirement | in the Resource Requirement |
| RR1 | RRL1 |
| RR2 | RRL1 + RRL2 |
| RR3 | RRL1 + RRL3 |
| RR4 | RRL1 + RRL2 + RRL4 |
| RR5 | RRL1 + RRL2 + RRL4 + RRL5 |
| RR6 | RRL1 + RRL2 + RRL4 + RRL6 |

In an example implementation, in presenting the resource requirements, the resource requirement set-up module 114 provides details of the set of resource redundancy levels and the corresponding requirements specifications for each resource requirement to the user. The user may select a resource requirement to view the details corresponding to that resource requirement. Based on the details provided and the application for which high availability is to be delivered, the user can select one of the resource requirements to plan IT resources. The application may include SAP, Oracle, or any other software application. The user selection of the resource requirement received by the resource requirement set-up module 114 for planning of IT resources through the resource planning system 102.

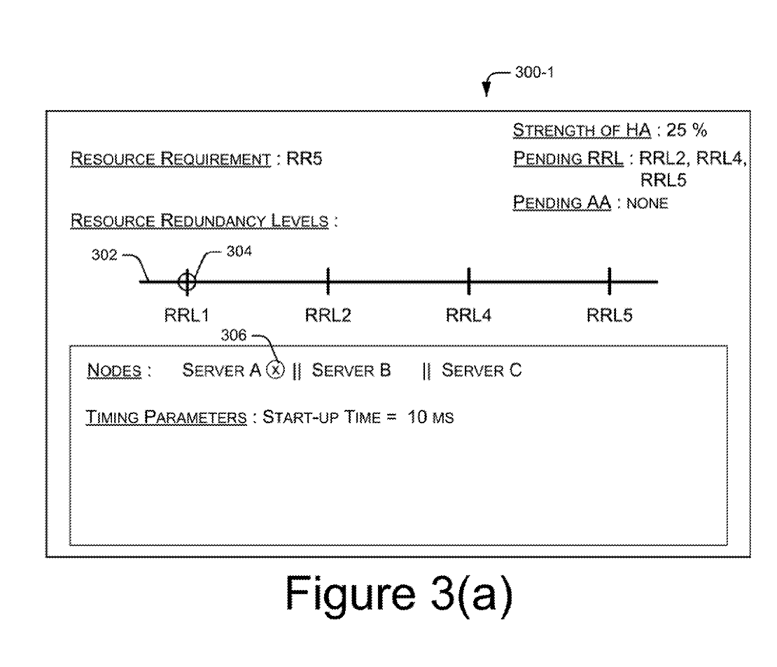

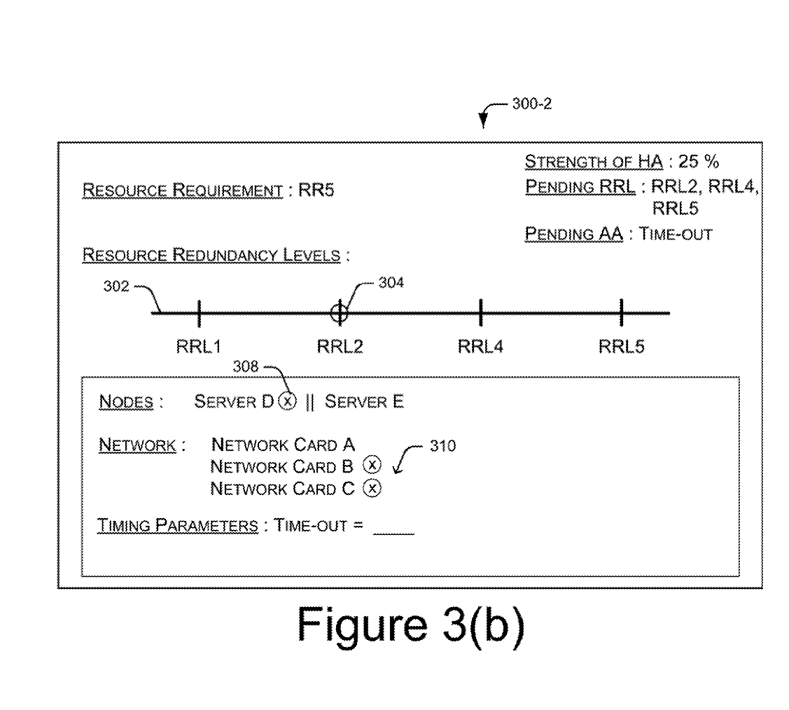

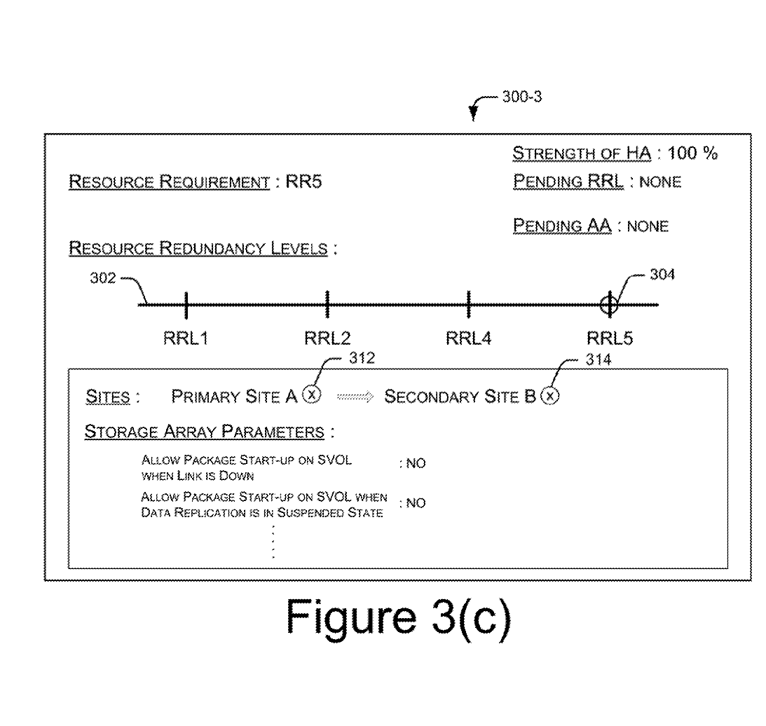

Based on the selection, the resource requirement set-up module 114 displays the set of resource redundancy levels corresponding to the selected resource requirement to the user. The display is through a user interface. The user interface is illustrated with reference to FIGS. 3(a), 3(b), and 3(c), and described in detail later in the description. In an example implementation, the resource redundancy levels may be displayed on a scale, starting from the base level to the higher level. The user can select the displayed resource redundancy levels, one by one, to plan the IT resources against the resource redundancy level to deliver high availability of the application.

In an example implementation, the resource identification module 116, at an instance, receives a user selection of one of the displayed resource redundancy levels, for planning IT resources. The description hereinafter describes the procedure of planning IT resources against one resource redundancy level received in the user selection. The same procedure can be repeated by the user to planning IT resources for other resource redundancy levels displayed by the resource requirement set-up module 114.

For planning the IT resources, the resource identification module 116 identifies IT resources present in the IT environment 100 which meet the redundancy requirements of the resource redundancy level. A predefined resource identification rule is set against each of the resource redundancy levels based on which IT resources present in the IT environment 100 can be identified. Table 3 illustrates the predefined resource identification rules, hereinafter referred to as the identification rules, associated with the resource redundancy levels illustrated in Table 1.

TABLE 3

| | Resource | Predefined Resource |
|---|---|---|
| | Redundancy Level | Identification Rule |
| RRL1 | Base | Find servers that host the similar |
| | | application. |
| RRL2 | Single Heartbeat + | Find servers with two or more |
| | Single Data | network cards. |
| RRL3 | Separate Heartbeat + | Find servers with three or more |
| | Single Data | network cards. |
| RRL4 | Virtual Machines on | Find virtual machines that run on |
| | Separate Hypervisor | hypervisors. |
| RRL5 | Asynchronous Data | Find data storage sites for |
| | Replication | asynchronous data replication. |
| RRL6 | Synchronous Data | Find data storage sites for |
| | Replication | synchronous data replication. |

For RRL1, the identification rule is set to identify servers 104 present in the IT environment 100 that host the same application for which. IT resource are being planned. With this, if the application or the dedicated server host the application fails, the application can be run through an alternate server. For RRL2, the identification rule is set to identify servers 104 present in the IT environment 100 that have two or more network cards. With this, the heartbeat can be communicated through one network card and the application data can be communicated through another network card. For RRL3, the identification rule is set to identify servers present in the IT environment 100 that have three or more network cards. With this, the heartbeat can be communicated through two separate network cards acting redundant to each other as a configuration, and the application data can be communicated through another network card. For RRL4, the identification rule is set to identify the virtual machines in the IT environment 100 that run on hypervisors. With this, each of the virtual machines can be run on a separate hypervisor. For RRL5, the identification rule is set to identify the data storage sites 108 present in the IT environment 100 that can be used to replicate and store the application data asynchronously. Similarly, for RRL6, the identification rule is set to identify the data storage sites 108 present in the IT environment 100 that can be used to replicate and store the application data synchronously.

In an example implementation, the resource identification module 116 may poll the various IT resources available in the IT environment 100 to identify the IT resources against the resource redundancy level. In polling, the resource identification module 116 may enable the resource planning system 102 to communicate with IT resources in the IT environment 100, in real-time, to identify the IT resources based on the identification rule.

In an example implementation, information of all the IT resources present in the IT environment 100 may be regularly updated/stored in a database (not shown). The database may be referred to as an information store. The information that may be stored includes identification attributes and functional attributes of the IT resources in the IT environment 100. The resource identification module 116 may enable the resource planning system 102 to communicate with such database to identify the IT resources present in the IT environment 100 against the resource redundancy level. In an example, the database may be populated with the information, in real-time, through polling of available IT resources or broadcasting of information of the available IT resources. In an example, the database may be populated with the information manually, in an offline manner.

Based on the identification of the IT resources, the resource allocation module 118 presents allocation attributes of the identified IT resources to the user based on which IT resources can be allocated by the user against the resource redundancy level. The allocation attributes may include identification attributes, such as names and identifier codes of the identified IT resources, and include functional attributes, such as time-outs for network components, start-up timings for servers, and storage array parameters for data replication at data storage sites. For the allocation of IT resources, the user can select the identification attributes corresponding to the IT resources. The user can also alter and set the functional attributes for the allocated IT resources. In an example implementation, the functional attributes presented to the user may be the predefined default values of functional attributes.

In an example implementation, the resource allocation module 118 may present an empty list of allocation attributes in case the relevant IT resources, based on the identification rule, are not present in the IT environment 100.

Further, based on the allocation by the user, the cluster configuration module 120 groups the allocated IT resources into a cluster, referred to as a high availability cluster. The IT resources allocated against the resource redundancy level and grouped in the cluster can be utilized to deliver high availability of the application with respect to the resource redundancy level.

The description below describes the details of allocation attributes that may be presented for allocation of IT resources against some of the resource redundancy levels illustrated in Table 1.

In an example, for RRL1, the identification attributes, such as names or identification codes of the servers 104 that can host the application are presented to the user. The user can select the identification attribute of a server 104 to allocate that server 104 for running the application in case the dedicated server fails. Also, in addition, the functional attributes, such as timing parameters, for example, start-up timings for the servers 104 and time-out for network communication with the servers 104, are also presented to the user. The presented functional attributes may be the default values. The user may allocate the server 104 based on the timing parameters. The user can also alter the timing parameters and set revised timing parameters. For example, depending on the type of application for which the IT resources are to be planned, the time taken to start the application on the server 104 may be set based on attributes, such as multi-core, memory, and CPU speed of the server 104. Similarly, the time-out for the communication of heartbeat signals may be set a higher value in the case where the communication channel is shared for the heartbeat communication and the application data communication. The server 104 is allocated against RRL1 to operate based on functional attributes set by the user.

In another example, for RRL2, the identification attributes, such as names or identification codes of the servers 104 having two or more network cards are presented to the user. Along with this, the identification attributes of all the network cards associated each server 104 are also presented to the user. The user can select the identification attribute of a server 104 to allocate that server 104 for using separate network cards for heartbeat communication and for application data. The user can also select the identification attribute of one of the network cards for the heartbeat communication, and select the identification attribute of another network card for the application data communication. Also, in addition, the functional attributes, such as time-out for the network communication with the server 104 are also presented to the user. The presented functional attributes may be default values. The user may allocate the server 104 based on the time-out. The user can also alter the time-out and set a revised time-out. For example, the time-out can be set depending on the type of server, the network card and the network interface. Similarly, the time-out for the communication of heartbeat signals may be set a lower value in the case where the communication channels are separate for the heartbeat communication and the application data communication. The server 104 and the network cards are allocated against RRL2 to operate based on time-out set by the user.

In another example, for RRL5, the identification attributes, such as names or identification codes of the data storage sites 108 in the IT environment 100 are presented to the user. For this, the identification attributes of the data storage sites 108 for replication of application data and for storing the replicated application data are presented to the user. The user can select the identification attribute of a data storage site 108 to allocate it as a primary site and select the identification attribute of another data storage site 108 to allocate it as a secondary site. The primary site can be the dedicated server running the application whose application data is to be replicated and stored, and the secondary site can be the back-up server for storing the replicated application data. Also, in addition, the functional attributes, such as storage array parameters for data replication on the secondary site are also presented to the user. The presented storage array parameters may be default values. The user may allocate the secondary site based on the storage array parameters. The user can also alter the storage array parameters, and set the revised ones. The storage array parameters may include parameters that define the rate at which the data is to be copied from the primary site to the secondary site. Such parameters are set to allow/disallow the following: (1) package start-up on secondary volume (SVOL) when link is down; (2) package start-up on SVOL when data replication is in the suspended state; (3) package start-up on primary volume (PVOL) after an outage of the PVOL has been fixed; (4) package fallback to the PVOL over suspended replication, and so on.

As mentioned eerier, the procedure as described above can be repeated by the user to planning IT resources for other resource redundancy levels displayed by the resource requirement set-up module 114. The resource identification module 116 identifies the IT resources present in the IT environment based on the resource redundancy level, and the user can allocate the IT resources based on the allocation attributes present to him by the resource allocation module 118. Further, the cluster configuration module 120 groups the IT resources against all the resource redundancy levels in the selected resource requirement into the same cluster based on which overall high availability of the application can be delivered in the IT environment 100.

In an example implementation, the resource allocation module 118 identifies pending allocation attributes from the presented allocation attributes. The pending allocation attributes are the attributes pending for selection or setting for allocation of IT resources against the resource redundancy level. The resource allocation module 118 may prompt the user to the select or set the pending allocation attribute to allocate the IT resources. The resource allocation module 118 may provide indications regarding the pending allocation attributes to the user. In an example implementation, the pending allocation attributes may be highlighted by different color codes, or by flashing, or by any other means. With this, the user gets an indication of the pending allocation attributes, and may take steps to select or set the pending allocation attributes for allocation of IT resources.

Further, in an example implementation, the resource requirement set-up module 114 identifies pending resource redundancy levels from the set of resource redundancy levels in the selected resource requirement. The pending resource redundancy levels are the levels pending for planning of IT resources. The resource requirement set-up module 114 may prompt the user to the select from the pending resource redundancy levels to plan the IT resources. The resource requirement set-up module 114 may provide indications regarding the pending resource redundancy levels to the user. In an example implementation, the pending resource redundancy levels may be highlighted: by different color codes, or by flashing, or by any other means. With this, the user gets an indication of the pending resource redundancy levels, and may take steps to select the pending resource redundancy levels for planning of IT resources.

Further, in an example implementation, the cluster configuration module 120 provides strength of high availability that will be delivered with respect to the selected predefined resource requirement. The strength of high availability depends on the ratio of the number of resource redundancy levels for which the IT resources have been planned to the total number of resource redundancy levels in the resource requirement selected by the user. The strength may be provided as a percentage.

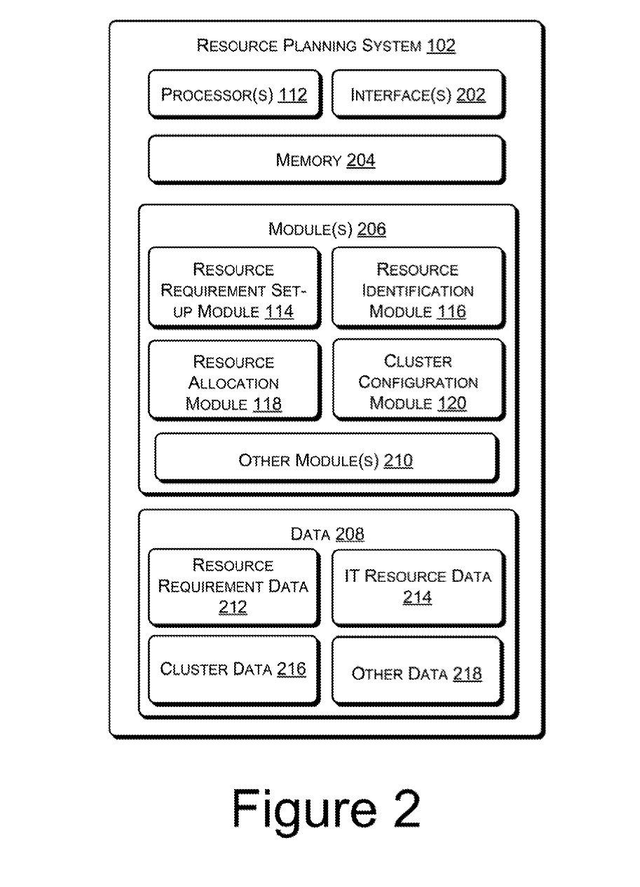

FIG. 2 illustrates the resource planning system 102, according to an example of the present subject matter. The resource planning system 102 includes the processor(s) 112 and also interface(s) 202. The interface(s) 202 may include a variety of machine readable instruction-based and hardware interfaces that allow the resource planning system 102 to interact with the servers 104, the computing devices 106, the data storage sites 108, and other devices in the IT environment 100. Further, the interface(s) 202 may enable the resource planning system 102 to communicate with other devices, such as network entities, web servers and other external repositories.

Further, the resource planning system 102 includes memory 204, coupled to the processor(s) 112. The memory 204 may include any computer-readable medium including, for example, volatile memory (e.g., RAM), and/or non-volatile memory (e.g., EPROM, flash memory, NVRAM, memristor, etc.).

Further, the resource planning system 102 includes module(s) 206 coupled to the processor(s) 112. The module(s) 206, amongst other things, include routines, programs, objects, components, data structures, and the like, which perform particular tasks or implement particular abstract data types. The module(s) 206 further include modules that supplement applications on the resource planning system 102, for example, modules of an operating system.

The module(s) 206 of the resource planning system 102 includes the resource requirement set-up module 114, the resource identification module 116, the resource allocation module 118, and the cluster configuration module 120, and other module(s) 210. The other module(s) 210 may include programs or coded instructions that supplement applications and functions, for example, programs in the operating system of the resource planning system 102.

Further, the resource planning system 102 includes data 208. The data 208 serves, amongst other things, as a repository for storing data that may be fetched, processed, received, or generated by the module(s) 206. Although the data 208 is shown internal to the resource planning system 102, it may be understood that the data 208 can reside in an external repository (not shown in the figure), which may be coupled to the resource planning system 102. The resource planning system 102 may communicate with the external repository through the interface(s) 202 to obtain information from the data 208.

In an example implementation, the data 208 of the resource planning system 102 includes resource requirement data 212, IT resource data 214, cluster data 216, and other data 218. The resource requirement data 212 stores data related to resource requirements, the resource redundancy levels, and corresponding specifications and identification rules. The resource requirement data 212 also stores the data related to the resource requirement selected by the user for planning the IT resources. The IT resource data 214 stores the data related to the identified IT resources and corresponding allocation attributes. The cluster data 216 stores the data related to IT resources allocated by the user to configure the high availability cluster. The other data 218 comprises data corresponding to other module(s) 210.

FIGS. 3(a), 3(b), and 3(c) illustrate examples of user interfaces (UIs) 300-1, 300-2, 300-3 for planning IT resources for delivering high availability of an application in an IT environment, according to an example of the present subject matter. To describe the UIs 300-1, 300-2, 300-3, consider a case where the resource requirement RR 5, as illustrated in Table 2, is selected by the user for planning the IT resources for delivering high availability of a particular application in the IT environment 100. The resource requirement RR5 includes the set of resource redundancy levels RRL1+RRL2+RRL4+RRL5, as illustrated in Table 2.

FIG. 3(a) illustrate the UI 300-1 that displays the RRL1 to RRL5 on a scale 302, starting from RRL1 to RRL5. The UI 300-1 also can display the details of RRL1, RRL2, RRL4, and RRL5 as “Base”, “Single Heartbeat+Single Data”, “Virtual Machines on Separate Hypervisors”, and “Asynchronous Data Replication”, respectively. The UI 300-1 illustrates the planning of IT resources for RRL1. The user selection indicating RRL1 for planning of IT resources is indicated by a marker 304. For RRL1, the UI 300-1 displays the identification attributes of the servers 104 that are identified by the resource planning system 102 based on the corresponding predefined identification rule (see Table 3). The identification attributes of the identified servers 104, for example, server A, server B, and server C, are displayed as “Nodes”. The user may select the identification attribute of one of the servers to allocate that server against RRL1. The allocation of the server is indicated by a marker 306. In addition, the UI 300-1 displays the functional attribute of the allocated server. The function attribute may be a timing parameter, for example, the start-up time to start the application on the allocated server. The user can set the start-up time for the allocated server. Further, the UI 300-1 displays the strength of high availability (“Strength of HA”), delivered with respect to RR5, as 25% after completion of planning of IT resources for RRL1. After completion of planning of IT resources for RRL1, the UI 300-1 displays the pending resource redundancy levels (“Pending RRL”) as RRL2, RRL4, and RRL5, and displays the pending allocation attributes (“Pending AA”) as “none”.

FIG. 3(b) illustrate the UI 300-2 that displays the RRL1 to RRL5 on the scale 302, starting from RRL1 to RRL5. The UI 300-2 illustrates the planning of IT resources for RRL2. The user selection indicating RRL2 for planning of IT resources is indicated by the marker 304. For RRL2, the UI 300-2 displays the identification attributes of the servers 104 that are identified by the resource planning system 102 based on the corresponding predefined identification rule (see Table 3). The identification attributes of the identified servers 104, for example, server D and server E, are displayed as “Nodes”. The UI 300-2 also displays the identification attributes of the network cards for each of the identified servers. The identification attributes of the network cards, for example, network card A, network card B, and network card C, are displayed as “Network”. The user may select the identification attribute of one of the servers and select the identification attributes of two network cards, one for heartbeat communication and other for application data communication. The selections are done to allocate the server and the two network cards against RRL2. The allocation of the server is indicated by a marker 308, and the allocation of the network cards is indicated by markers 310. In addition, the UI 300-1 displays the functional attribute for the communication through the allocated server and the allocated network cards. The function attribute may be a timing parameter, for example, the time-out value. The user can set the time-out value or accept the default time-out value displayed on the UI 300-2. As shown, since the time-out value is pending for setting, the UI 300-2 displays “Time-out” as the pending allocation attributes (“Pending AA”). Further, since the planning of IT resources for RRL2 is not completed, the UI 300-1 displays the strength of high availability (“Strength of HA”), delivered with respect to RR5, as 25%. The UI 300-2 also displays the pending resource redundancy levels (“Pending RRL”) as RRL2, RRL4 and RRL5.

FIG. 3(c) illustrate the UI 300-3 that displays the RRL1 to RRL5 on the scale 302, starting from RRL1 to RRL5. The UI 300-3 illustrates the planning of IT resources for RRL5. The user selection indicating RRL5 for planning of IT resources is indicated by the marker 304, For RRL5, the UI 300-3 displays the identification attributes of the data storage sites 108 that are identified by the resource planning system 102 based on the corresponding predefined identification rule (see Table 3). The identification attributes of the identified data storage sites 108 are displayed as “Sites”. The user may select the identification attribute of one of the data storage sites 108 as a primary site A whose application data is to be replicated, and select the identification attributes of another data storage site 108 as a secondary site B where the replicated data is to be stored. The selections are done to allocate the primary and secondary sites against RRL2. The allocation of the primary site A is indicated by a marker 312, and the allocation of the secondary site B is indicated by a marker 314. The arrow between the primary site A and the secondary site B indicates the direction of data replication and storage. In addition, the UI 300-3 displays the functional attributes for data replication. The function attributes may be storage array parameters, for example, the parameters that allow/disallow (1) package start-up on secondary volume (SVOL) when link is down, (2) package start-up on SVOL when data replication is in the suspended state, (3) package start-up on primary volume (PVOL) after an outage of the PVOL has been fixed, (4) package fallback to the PVOL over suspended replication, and so on. The user can set such parameters or accept the default values of the parameters displayed on the UI 300-3. Further, after completion of planning of IT resources for RRL5, the UI 300-3 displays the strength of high availability (“Strength of HA”), delivered with respect to RR5, as 100%. Also, after completion of planning of IT resources for RRL5, the UI 300-3 displays the pending resource redundancy levels (“Pending RRL”) as “none”, and displays the pending allocation attributes (“Pending AA”) as “none”.

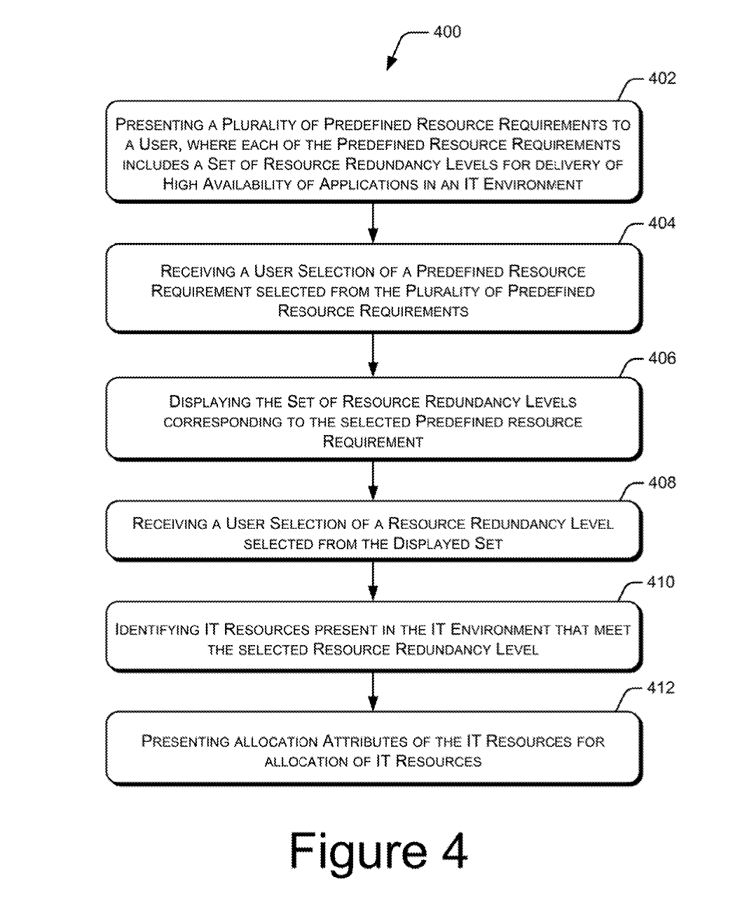

FIG. 4 illustrates a method 400 of planning IT resources for delivering high availability of an application in an IT environment, according to an example of the present subject matter. The method 400 is directed to describe the planning of IT resources for delivering high availability of one application; the method 400, in a similar manner, may be performed for planning of IT resources for delivering high availability of multiple applications.

The order in which the method 400 is described is not intended to be construed as a limitation, and any number of the described method blocks can be combined in any order to implement the method 400, or an alternative method. Furthermore, the method 400 can be implemented by processor(s) or computing device(s) through any suitable hardware, non-transitory machine readable instructions, or combination thereof.

It may be understood that steps of the method 400 can be performed by programmed computing devices. The steps of the methods 400 can be executed based on instructions stored in a non-transitory computer readable medium, as will be readily understood. The non-transitory computer readable medium may include, for example, digital memories, magnetic storage media, such as a magnetic disks and magnetic tapes, hard drives, or optically readable digital data storage media.

Further, although the method 400 for planning of IT resources for delivering high availability of an application may be implemented in a variety of computing devices working in different IT environments; in an embodiment described in FIG. 4, the method 400 is explained in context of the aforementioned resource planning system 102 in the IT environment 100, for ease of explanation.

Referring to FIG. 4, at block 402, a plurality of predefined resource requirements associated with delivery of high availability of applications are presented to the user by the resource planning system 102. Each of the predefined resource requirements includes a set of resource redundancy levels that indicate requirements of resource redundancy at different levels for delivery of high availability of applications at those levels. The set may include one or more resource redundancy levels. Examples of predefined resource requirements, and the resource redundancy levels that may be comprised in the exemplary predefined resource requirement, are illustrated in Table 1 and Table 2.

At block 404, a user selection of one of the predefined resource requirements, selected for planning IT resources for delivery of high availability of an application, is received by the resource planning system 102. The user may selected any one of the predefined resource requirements based on the application for which high availability is to be delivered, and based on the resource redundancy levels in the predefined resource requirements.

After receiving the predefined resource requirement selected by the user, the set of resource redundancy levels corresponding to the selected predefined resource requirement is displayed by the resource planning system 102, at block 406. The display is through a user interface, as illustrated through FIGS. 3(a), 3(b), and 3(c).

At block 408, a user selection of one of the displayed resource redundancy levels is received by the resource planning system 102. The user selection is for planning the IT resources to meet the selected resource redundancy level. As mentioned earlier, at an instance, the user can select one of the resource redundancy levels displayed by the resource planning system 102. The user can select the displayed resource redundancy levels one by one for planning of IT resource against the each.

Upon receiving the user selection, IT resources present in the IT environment 100 that meet the resource redundancy level indicated in the user selection are identified by the resource planning system 102, at block 410. The identification of IT resources present in the IT environment 100 is based on a predefined resource identification rule corresponding to the resource redundancy level indicated in the user selection. Examples of predefined resource identification rules, corresponding to the exemplary resource redundancy levels of Table 1, are illustrated in Table 3. In an example implementation, the IT resource may be identified based on polling of IT resources in the IT environment 100 in real-time by the resource planning system 102. In an example implementation, IT resource may be identified by the resource planning system 102 based on communication with a database that stores the information of IT resources present in the IT environment 100.

At block 412, allocation attributes of the identified IT resources are present to the user by the resource planning system 102. The allocation attributes are presented so that the user can allocate IT resources against the resource redundancy level, to configure a cluster. The cluster is referred to as a high availability cluster. With this, the high availability of the application can be delivered in the IT environment 100 at the level indicated by the resource redundancy level. The details of presentation of allocation attributes of the identified IT resources and the allocation of IT resources against resource redundancy levels are mentioned earlier in the description.

In configuring the cluster, the allocated IT resources are grouped into the cluster by the resource planning system 102, to deliver high availability of the application. As mentioned earlier, the procedure of planning of IT resources can be repeated by the user for each of the displayed resource redundancy levels. The IT resources allocated during the planning of IT resources for all the displayed resource redundancy levels are grouped: into the same cluster, to deliver high availability of the application at the levels indicated in the predefined resource requirement selected by the user.

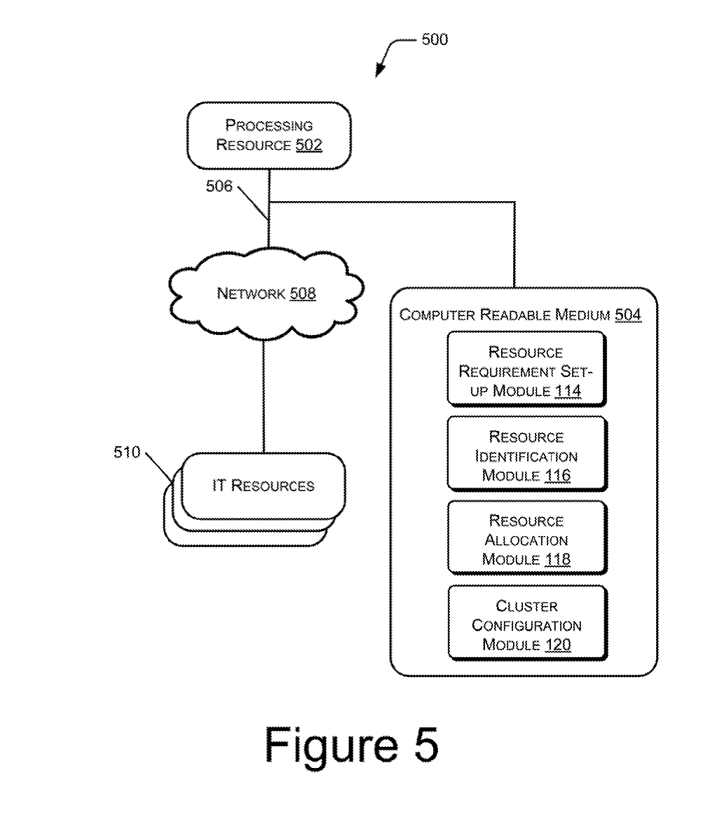

FIG. 5 illustrates a network environment 500 for planning IT resources for delivering high availability of an application in an IT environment, according to an example of the present subject matter. The network environment 500 may be a public networking environment or a private networking environment. In an example implementation, the network environment 500 includes a processing resource 502 communicatively coupled to a computer readable medium 504 through a communication link 506.

For example, the processing resource 502 can be a computing device, such as a computer, for planning IT resources. The computer readable medium 504 can be, for example, an internal memory device or an external memory device. In an example implementation, the communication link 506 may be a direct communication link, such as any memory read/write interface. In another example implementation, the communication link 506 may be an indirect communication link, such as a network interface. In such a case, the processing device 502 can access the computer readable medium 504 through a network 508. The network 508 may be a single network or a combination of multiple networks and may use a variety of different communication protocols.

The processing resource 502 and the computer readable medium 504 may also be communicatively coupled to IT resources 510 over the network 508. The IT resources 510 can include, for example, desktop computers, laptops, servers, and data storage sites. The coupling with the IT resources 510 enables in planning IT resources, for delivering high availability of applications, through the processing resource 502, in accordance with the present subject matter.

In an example implementation, the computer readable medium 504 includes a set of computer readable instructions, such as the resource requirement set-up module 114, the resource identification module 116, the resource allocation module 118, and the cluster configuration module 120. The set of computer readable instructions can be accessed by the processing resource 502 through the communication link 506 and subsequently executed to perform acts for planning IT resources for delivering high availability of application in the IT environment.

For example, the resource requirement set-up module 114 can present a plurality of predefined resource requirements to the user. The predefined resource requirements are associated with delivery of high availability of application in the IT environment, and each of the predefined resource requirements includes a set of resource redundancy levels for delivery of high availability. The resource requirement set-up module 114 can receive a predefined resource requirement selected by the user for planning of IT resources. The user may selected any one of the predefined resource requirements based on the application for which high availability is to be delivered, and based on the resource redundancy levels in the predefined resource requirements. Based on the selection, the resource requirement set-up module 114 can display the set of resource redundancy levels corresponding to the predefined resource requirement selected by the user.

The resource identification module 116 can receive a user selection of one resource redundancy level selected based of the display. Based on the user selection, the resource identification module 116 can identify IT resources present in the IT environment that meet the selected resource redundancy level. The resource identification module 116 can identify the IT resources based on a predefined resource identification rule corresponding to the selected resource redundancy level.

The resource allocation module 118 can present allocation attributes of the identified IT resources for the user to allocate IT resources against the resource redundancy level, to meet the resource redundancy level. The cluster configuration module 120 can group the IT resources into a cluster, based on the allocation by the user, to deliver high availability of the application in the IT environment.

Although implementations for planning IT resources for delivering high availability of applications in an IT environment have been described in language specific to structural features and/or methods, it is to be understood that the present subject matter is not necessarily limited to the specific features or methods described. Rather, the specific features and methods are disclosed and explained as example implementations for planning IT resources for delivering high availability of applications in an IT environment.

We claim:

1. A method of planning IT resources comprising:
presenting, by a computing device, a plurality of predefined resource requirements associated with delivery of high availability of applications in an IT environment to a user, wherein each of the plurality of predefined resource requirements comprises a set of resource redundancy levels for delivery of high availability;
receiving a user selection of a predefined resource requirement selected from the plurality of predefined resource requirements;
displaying the set of resource redundancy levels corresponding to the selected predefined resource requirement;
receiving a user selection of a resource redundancy level selected from the displayed set;
identifying IT resources present in the IT environment that meet the selected resource redundancy level; and
presenting allocation attributes of the IT resources for allocation of IT resources.

2. The method as claimed in claim 1 further comprising grouping the IT resources into a high availability cluster, based on the allocation.

3. The method as claimed in claim 1 further comprising:
identifying pending allocation attributes, wherein the pending allocation attributes are allocation attributes of the IT resources pending for one of selection and setting against the selected resource redundancy level; and
prompting the user to select or set the pending allocation attributes.

4. The method as claimed in claim 1 further comprising:
identifying pending resource redundancy levels, wherein the pending resource redundancy levels are from the displayed set of resource redundancy levels, against which planning of IT resources is pending; and
prompting the user to plan IT resources against the pending resource redundancy levels.

5. The method as claimed in claim 1 further comprising providing a strength of high availability delivered with respect to the selected predefined resource requirement, wherein the strength of high availability is based on number of resource redundancy levels, from the displayed set of resource redundancy levels, against which IT resources are planned.

6. The method as claimed in claim 1, wherein the identifying is based on polling of IT resources in the IT environment in real-time.

7. The method as claimed in claim 1, wherein the identifying is based on a predefined resource identification rule associated with the selected resource redundancy level.

8. A resource planning system comprising:
a processor;
a resource requirement set-up module coupled to the processor to,
present a plurality of predefined resource requirements associated with delivery of high availability of applications in an IT environment to a user, wherein each of the plurality of predefined resource requirements include a set of resource redundancy levels for delivery of high availability; and
receive a user selection of a predefined resource requirement selected from the plurality of predefined resource requirements;
a resource identification module coupled to the processor to,
receive a user selection of a resource redundancy level, wherein the user selection is based on display of the set of resource redundancy levels corresponding to the selected predefined resource requirement; and
identify IT resources present in the IT environment that meet the selected resource redundancy level;
a resource allocation module coupled to the processor to present allocation attributes of the IT resources for allocation of IT resources; and
a cluster configuration module coupled to the processor to group the IT resources into a high availability cluster, based on the allocation.

9. The resource planning system as claimed in claim 8, wherein the resource allocation module
identifies pending allocation attributes, wherein the pending allocation attributes are allocation attributes of the IT resources pending for one of selection and setting against the selected resource redundancy level; and
prompts the user to select or set the pending allocation attributes.

10. The resource planning system as claimed in claim 8, wherein the resource requirement set-up module
identifies pending resource redundancy levels, wherein the pending resource redundancy levels are from the displayed set of resource redundancy levels, against which planning of IT resources is pending; and
prompts the user to plan IT resources against the pending resource redundancy levels.

11. The resource planning system as claimed in claim 8, wherein the resource identification module identifies the IT resources based on polling of IT resources in the IT environment in real-time.

12. The resource planning system as claimed in claim 8, wherein the allocation attributes of the IT resources comprise identification attributes of the IT resources and function attributes of the IT resources.

13. A non-transitory computer-readable medium comprising computer readable instructions that, when executed, cause a resource planning system to:
present a plurality of predefined resource requirements associated with delivery of high availability of applications in an IT environment to a user, wherein each of the plurality of predefined resource requirements include a set of resource redundancy levels for delivery of high availability;
receive a user selection of a predefined resource requirement selected from the plurality of predefined resource requirements;
display the set of resource redundancy levels corresponding to the selected predefined resource requirement;
receive a user selection of a resource redundancy level selected from the displayed set;
identify IT resources present in the IT environment that meet the selected resource redundancy level, wherein the identifying is based on a predefined resource identification rule associated with the selected resource redundancy level;
present allocation attributes of the IT resources for allocation of IT resources; and
group the IT resources into a high availability cluster, based on the allocation.

14. The non-transitory computer-readable medium as claimed in claim 13 comprises to poll IT resources in the IT environment, in real-time, to identify the IT resources.
